(19) United States
(12) Patent Application Publication
(10) Pub. No.: US 2026/0270935 A1
(43) Pub. Date: Sep. 10, 2026

(54) METHODS AND ARRANGEMENTS FOR MEASUREMENT GAPS

(71) Applicant: Intel Corporation, Santa Clara, CA (US)

(72) Inventors: Rui HUANG, Beijing (CN); Andrey CHERVYAKOV, Maynooth (IE); Meng ZHANG, Beijing (CN); Hua LI, Beijing (CN); Gang XIONG, Portland, OR (US)

(73) Assignee: Intel Corporation, Santa Clara, CA (US)

(21) Appl. No.: 19/162,624

(22) PCT Filed: Apr. 5, 2024
(86) PCT No.: PCT/US2024/023371

§ 371 Date: Sep. 5, 2025

Related U.S. Application Data
(60) Provisional application No. 63/494,677, filed on Apr. 6, 2023.

(51) Int. Cl. H04W 64/00; G01S 5/02

(52) U.S. Cl. CPC H04W 64/00; G01S 5/0221

(57) ABSTRACT

Logic may determine, based on a PRS configuration, a frequency range of a PRS, wherein the PRS configuration defines resource blocks of frequency layers of the PRS. Logic may determine a number of frequency hops between frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay. Logic may perform the number of frequency hops and measurements of the PRS during each of the repetitions of the one measurement gap or the up to two measurement gaps. And logic may cause transmission of at least one positioning measurement report via the interface.

### CROSS REFERENCE TO RELATED APPLICATIONS

This application also claims priority under 35 USC § 119 from U.S. Provisional Application No. 63/494,677, entitled “MEASUREMENT GAPS FOR REDCAP USER EQUIPMENT POSITIONING WITH RECEIVER HOPPING”, filed on Apr. 6, 2023, the subject matter of which is incorporated herein by reference.

### BACKGROUND

The rapid growth of wireless communication technologies and the increasing demand. The demand for 5G devices with reduced capability is growing rapidly. Reduced capability (RedCap) NR (New Radio) devices aim to simplify user equipment (UE) complexity while maintaining essential functionality. These devices are designed to operate efficiently with lower power consumption and relaxed performance characteristics.

The RedCap NR reduces UE complexity through several mechanisms. For instance, the RedCap NR may reduce the number of receive and transmit (RX/TX) antennas, lower bandwidth requirements, lower and/or optimize UE power consumption or usage, relax data rates with less stringent data rate requirements, relax UE processing time by reducing processing demands, and adapt processing capability for specific use cases.

Some the use cases for the Redcap UEs may include industrial wireless sensors for monitoring and control applications, video surveillance for efficient camera deployments, and wearable devices with reduced complexity.

### BRIEF DESCRIPTION OF THE DRAWINGS

FIG. 1 depicts an embodiment of a system including base stations, user equipment, and cloud-based computing and data services interconnected via a communication network;

FIG. 2 illustrates another embodiment of a network in accordance with various embodiments such as the network in FIG. 1;

FIG. 3 illustrates another embodiment of a network in accordance with various embodiments;

FIG. 4 illustrates an embodiment of a simplified block diagram of artificial (AI)-assisted communication between a UE and a RAN, in accordance with various embodiments;

FIG. 5 is an embodiment of a simplified block diagram of a base station and a user equipment (UE) such as the base stations or RANs, the UEs, and communication networks shown in FIGS. 1-4;

FIG. 6 depicts a table of gap combination configurations;

FIG. 7 depicts a flowchart of an embodiment for a user equipment such as the embodiments described in conjunction with FIGS. 1-6;

FIG. 8 depicts an embodiment of protocol entities that may be implemented in wireless communication devices;

FIG. 9 illustrates embodiments of the formats of PHY data units (PDUs) that may be transmitted by the PHY device via one or more antennas and be encoded and decoded by a MAC entity such as the processors in FIG. 5, the baseband circuitry in FIGS. 5, 13, and 14 according to some aspects;

FIGS. 10A-B depicts embodiments of communication circuitry such as the components and modules shown in the user equipment and base station shown in FIG. 5;

FIG. 11 depicts an embodiment of a storage medium described herein;

FIG. 12 illustrates an architecture of a system of a network in accordance with some embodiments;

FIG. 13 illustrates example components of a device in accordance with some embodiments such as the base stations and UEs shown in FIGS. 1-12;

FIG. 14 illustrates example interfaces of baseband circuitry in accordance with some embodiments such as the baseband circuitry shown and/or discussed in conjunction with FIGS. 1-13; and

FIG. 15 depicts an embodiment of a block diagram of components to perform functionality described.

### DETAILED DESCRIPTION OF EMBODIMENTS

The following is a detailed description of embodiments depicted in the drawings. The detailed description covers all modifications, equivalents, and alternatives falling within the appended claims.

Historically, the main driver for location-based services has been requirements from regulatory authorities (e.g., emergency caller location requirements). However, today, many public and private entities demand delivery of location information to enable commercially motivated location-based services, which often require higher location accuracy and precision. Consequently, fifth generation (5G) cellular networks support several enhanced location services capabilities and new radio (NR) native positioning technologies to address the diverse location requirements resulting from new applications and industry verticals.

5G NR provides a few enhanced parameters for positioning accuracy estimation than previous mobile generations, particularly with regards to time- and angle-based positioning methods. To enable more accurate positioning measurements than long term evolution (LTE), new reference signals were added to the NR specifications. These signals are the positioning reference signal (NR PRS) in the downlink and the sounding reference signal (SRS) for positioning in the uplink. The downlink positioning reference signal (PRS) is the main reference signal supporting downlink-based positioning methods. Although other signals can be used, PRS is specifically designed to deliver the highest possible levels of accuracy, coverage, and interference avoidance and suppression. To design an efficient PRS, special care was taken to give the signal a large delay spread range, since it must be received from potentially distant neighboring base stations for position estimation. This is achieved by covering the whole NR bandwidth and transmitting PRS over multiple symbols that can be aggregated to accumulate power.

The density of subcarrier occupied in a given PRS symbol is referred to as the comb size. There are several configurable comb-based PRS patterns for comb-2,4,6 and 12 suitable for different scenarios serving different use cases. For comb-N PRS, N symbols can be combined to cover all the subcarriers in the frequency domain. Each base station can then transmit in different sets of subcarriers to avoid interference. Since several base stations can transmit at the same time without interfering with each other, this solution is also latency efficient. Moreover, it is possible to mute the PRS signal from one or more base stations at a given time according to a muting pattern, further lowering the potential interference. For use cases with higher transmission loss (for example, in macro cell deployments) the PRS can be also configured to be repeated to improve reception.

In the uplink direction, 3GPP introduced the SRS for positioning in 3GPP Release 16. This new signal resolves two aspects specific to positioning. Since positioning involves measurements from multiple receiving base stations, the new signal must have enough range to reach not only the serving base station to which the UE is connected, but also the neighboring base stations involved in the positioning process. The SRS is also designed to cover the full bandwidth, where the resource elements are spread across the different symbols so as to cover all subcarriers. Therefore, SRS is also designed with a comb-based pattern similar to the PRS. UEs can be multiplexed over the same transmitting symbol by assigning different comb patterns. To minimize interference, the UE can be configured with different SRS instances, each with independent power control loops. This allows SRS pointed at neighbor cells to have better reception and keeps the interference low in the serving cell.

Different positioning methods may require different measurements. 3GPP has standardized power, angular and time measurement support for the PRS. Each beam can be seen as a resource. Measurements are collected across one or multiple resource and resource sets. Beamforming improves the signal to noise ratio (SNR) due to beamforming gain besides providing UE location information in terms of the angle of departure (AOD) based on the beam ID accessed by the UE, while a large number of antennas at the receiver in the uplink enables fine angle of arrival (AOA) measurements with NR. Many of these measurements are standardized to enable variety of positioning methods. Since 4G LTE, mobile networks have supported observed time difference of arrival (OTDOA), uplink time difference of arrival (UL-TDOA) and positioning methods based on power measurements. In 5G, the list of supported methods is extended to include round trip time (RTT) and angle-based positioning. The inclusion of new positioning methods and enhancements of existing positioning methods enables high accuracy positioning for several use cases in 5G.

Rel-18 NR extends its reach to accommodate positioning functionality for RedCap UEs. These UEs have limited capability and complexity and operate with fewer radio frequency (RF) chains and strictly limited bandwidth (BW) of 20 MHz in frequency range 1 (FR1), i.e., sub-6 GHz frequency bands, and 100 MHz in FR2. To overcome this BW limitations, Rel-18 NR introduces frequency hopping for positioning measurements. This enables RedCap UEs to maintain satisfactory positioning accuracy, despite their BW limitations, opening up a wider range of application possibilities for these devices.

The accuracy of timing measurements such as reference signal time difference (RSTD) and Rx-Tx time difference is highly impacted by the BW size of the reference signal (RS). In FR1, the BW of downlink (DL) PRS and uplink (UL) SRS of normal NR UEs is limited to a maximum BW of 100 MHz. To overcome the limitation, Rel-18 NR introduces BW aggregation for positioning measurements. This feature allows Tx/Rx architectures with a single RF chain to receive and combine two or three intra-band contiguous component carriers (CCs), increasing the effective BW for positioning measurements. Through BW aggregation, the BW of the DL PRS and the UL SRS can be extended beyond the individual CC limit, leading to more accurate timing measurements.

In Rel-18, features introduced in the previous releases of NR positioning are supported for RedCap positioning by means of frequency hopping such as DL PRS frequency hopping and UL SRS frequency hopping.

For DL PRS frequency hopping, RedCap UEs can receive a part of the wideband DL PRS, called as a frequency hop. By sequentially receiving multiple frequency hops and combining them, RedCap UEs can effectively process wideband DL PRS signals, despite the RedCap UEs limited instantaneous maximum BW. However, there are challenges such as RF retuning and phase differences. RedCap UEs must retune their RF receiver at different frequency hops, resulting in phase differences between the frequency hops.

To accurately reconstruct the wideband DL PRS, these phase differences between the frequency hops must be compensated. One solution is to overlap resource blocks (RBs) of frequency ranges between frequency hops. By receiving DL PRS from overlapping RBs in adjacent frequency hops, UEs can estimate and correct for the phase difference.

The UE receives the DL PRS from a frequency hop over two symbols and performs RF re-tuning in the following two symbols. For a gNB that is sufficiently close to the UE, two symbols per frequency hop can be enough. However, longer reception periods are likely to be needed for each frequency hop to ensure adequate signal strength if gNBs are further away, potentially resulting in longer delays.

RedCap UEs have flexibility to operate either with or without frequency hopping. In particular, UEs can acquire positioning measurements from a single frequency hop of the DL PRS, bypassing the complexity of radio frequency (RF) retuning and frequency hopping. On the other hand, RedCap UEs can leverage frequency hopping to construct a wider bandwidth DL PRS, although this needs measurement gaps to be configured in the data reception bandwidth in order to retune to make the measurements on other frequencies. In the RRC_CONNECTED state, DL PRS frequency hopping is done within a measurement gap. In the RRC_INACTIVE state, the UE performs frequency hopping in selected discontinuous reception (DRX) ON periods.

UEs may inform the LMF whether measurements are from a single or multiple frequency hops, which may enable the LMF to prioritize measurements derived from multiple hops for better accuracy.

For UL SRS frequency hopping, RedCap UEs can use UL SRS frequency hopping to transmit wideband UL SRS signals in segments, called frequency hops, such as 20 MHz out of 100 MHz SRS in FR1. SRS frequency hopping necessitates a separate SRS configuration including virtual frequency resource allocation, BW per frequency hop, starting PRB, overlapping RBs, periodicity, offsets, and time duration of each frequency hop. Base stations (such as gNBs) can provide time windows with a length of 1, 2, 4, or 6 slots to prioritize SRS frequency hopping over data communications. This ensures uninterrupted SRS transmission in all frequency hops for gNBs to accurately reconstruct the wideband SRS. However, if the window is not provided, the other UL signals are mostly prioritized over SRS transmission, which facilitates stable data communications but could result in a delay to obtain positioning measurements.

A single ZC sequence for the SRS transmission is generated based on subcarriers of the overall SRS frequency hops, even though the RedCap UE cannot transmit the whole ZC sequence at the same time. That is, although there are frequency resources that the UE cannot use at a specific time, the frequency resources are virtually allocated for the SRS frequency hopping. Adjacent frequency hops intentionally share a portion of the ZC sequence elements with a length, L, enabling gNBs to estimate and compensate for phase differences between the frequency hops. Similar to DL PRS frequency hopping, to optimize measurement utilization, gNBs explicitly indicate to LMF whether measurements were derived from single or multiple frequency hops.

The LMF may coordinate the time and frequency resources for SRS within the validity area to avoid interference. Within the validity area, the UE may autonomously adjust the timing advance when cell-reselection occurs. When a UE is configured to measure PRS or transmit SRS for positioning, it can perform radio resource management (RRM) measurements for positioning within the configured measurement reporting periodicity or SRS transmission periodicity.

Embodiments generally relate to network communication, cellular networks, data centers, network topologies, edge computing, cloud computing, and communication system implementations, and in particular, to measurement gaps for reduced capability (RedCap) user equipment (UE) positioning with receiver (Rx) frequency hopping. Embodiments may enable UEs with RedCap measurements for positioning purposes by adapting radio resource management (RRM) aspects for measurement requirements related to frequency hopping of PRS and/or SRS. For example, for at least RAN4, RedCap UEs may support at least measurements on downlink (DL) PRS with receive (Rx) frequency hopping using a measurement gap. Support for measurements on DL PRS with Rx frequency hopping using a measurement gap may involve:
RedCap UE processing capabilities for DL PRS with Rx frequency hopping and measurement gap (MG)
the use of a single or multiple instances of MGs; and
the use of power per watt (PPW) for Redcap UEs

PPW measures the amount of power (in watts) consumed by a UE to achieve a specific performance level. A lower PPW indicates better energy efficiency. Efficient UEs consume less power for the same level of service, leading to longer battery life and reduced environmental impact. Lowering the PPW may reduce data rates, reduce coverage, and increase latencies related to signaling by Redcap UEs. Lowering the PPW may also balance energy savings with quality of service (QoS) requirements.

RedCap UEs may operate in both Frequency Range 1 (FR1) (410 MHZ-7125 MHz) and Frequency Range 2 (FR2) (24250 MHz-52600 MHZ-71000 MHz). The maximum UE bandwidth may be 20 MHz for FR1 and 100 MHz for FR2. In some embodiments, the Redcap UE may support one Rx branch and, in some embodiments, the Redcap UE may support DL multiple-input-multiple-output (MIMO).

MIMO is a general class of technologies that incorporates a number of transmission and reception techniques using multiple antennas. Spatial multiplexing (SM) involves the transmission of multiple data streams, called layers (or frequency layers) in 3GPP specifications. In a single user (SU) MIMO (SU-MIMO), spatial multiplexing involves directing multiple streams to one user. For multiple user (MU) MIMO (MU-MIMO), the layers may be split among users.

MIMO may include several forms of multi-antenna techniques in the form of transmission modes. The MIMO formats include single-antenna, transmit diversity, open-loop SU-MIMO, closed-loop SU-MIMO, closed-loop rank-1 precoding (beamforming), and MU-MIMO. The introduction of larger antenna arrays enabled multi-layer beamforming (BF), which is different from previous SM by using multiple antennas for each layer.

Precoding refers to the multiplexing of the data streams onto the antenna ports. An antenna port may represent a non-unique subset of antenna elements controlled by radio frequency (RF) circuitry often referred to as an RF chain. Each transmission may utilize a set of RF chains in the RF circuitry to transmit data on multiple subcarriers (also referred to as tones) of a transmission bandwidth about a carrier frequency.

In some embodiments, the radio resource management (RRM) may optionally support extended discontinuous reception (eDRX) for Redcap UEs to advantageously reduce power consumption during periods with relaxed DL latency as well as a relaxation of neighbor-cell measurements to save power.

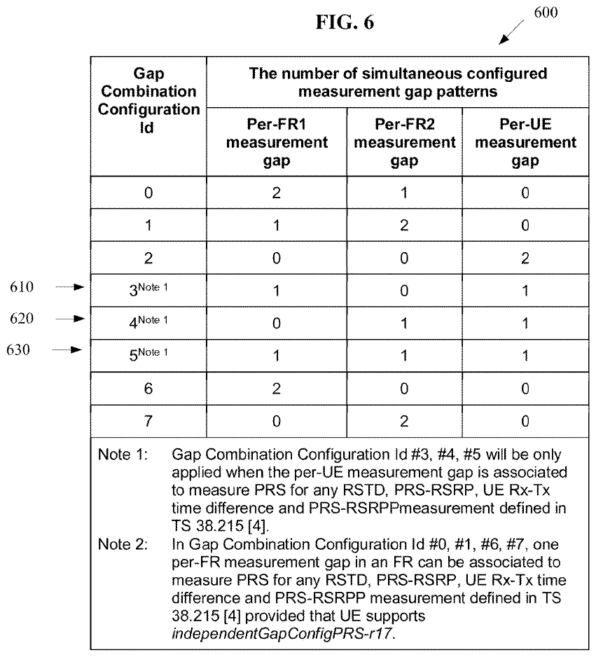

Embodiments herein may advantageously define gap-based measurements with frequency hopping for RedCap UEs. For gap-based reference signal time difference (RSTD), positioning reference signal-reference signal received power (PRS-RSRP), UE Rx-Tx time difference, and positioning reference signal-reference signal received path power (PRS-RSRPP) measurements, the requirements in the RRM specification 3GPP Technical Specification (TS) 38.133 clauses 9.9A.2, 9.9A.3, 9.9A.4 and 9.9A.5 (e.g., 3GPP TS 38.133 V18.4.0 (2023-12) or later) may apply provided:
the RedCap UE is configured or pre-configured with measurement gaps or configured with concurrent measurement gaps
all positioning frequency layers are measured or associated with only one per-UE measurement gap, or
for the RedCap UE supporting independentGapConfigPRS-r17, all positioning frequency layers in the same FR are measured or associated with only one per-FR measurement gap in the corresponding FR.
if the measurement gap is pre-configured, the measurement gap must be activated throughout the measurement period, and
if concurrent measurement gaps are configured, one of the measurement gap combinations specified in TS 38.133 clause 9.1.8.2 is configured (see table 600 in FIG. 6), and
if the RedCap UE does not support independentGapConfigPRS-r17, the configured or pre-configured gap used to perform the PRS measurements must be of per-UE type, and
No active BWP switching occurs during the measurement gaps for PRS measurement, and

All measurement requirements specified in TS 38.133 clause 9.9A.2, 9.9A.3, 9.9A.4 and 9.9A.5 may apply without DRX as well as for any DRX configuration specified in the RRC protocol specification TS 38.331 (e.g., 3GPP TS 38.331 V18.0.0 (2023-12)).

In some embodiments, a RedCap UE is only required to measure PRS resources that are fully or partially overlapped with measurement gaps, and the requirements in TS 38.133 clauses 9.9A.2, 9.9A.3, 9.9A.4 and 9.9A.5 are applicable to PRS resources that are fully or partially overlapped with measurement gaps.

A PRS resource is considered to be fully (partially) overlapped with measurement gaps if all (some) of its instances are overlapped with a measurement gap occasion. A PRS resource instance is considered to be overlapped with measurement gap occasion if the minimum number of unmuted repetitions of the instance taking into account nr-DL-PRS-ExpectedRSTD-Uncertainty and nr-DL-PRS-ExpectedRSTD is fully covered by the measurement gap length (MGL) excluding RF switching time (time for RF re-tuning for each frequency hop), where:
the minimum number is given (specified in TS 38.133) in the accuracy requirements with frequency hop (FH) for 2 receiver (2Rx) RedCap UEs, and
the minimum number is given (specified in TS 38.133) in the accuracy requirements with FH for one receiver (1Rx) RedCap UEs.

When RedCap UE is configured with measurement for more than one positioning requests, the measurement period for each request may be longer than measurement period when RedCap UE is configured with measurement for single positioning request.

If a positioning measurement gap is configured via PosGapConfig and activated by medium access control-control element (MAC CE), the measurement requirements in clause 9.9A.2, 9.9A.3, 9.9A.4 and 9.9A.5 may apply provided that no other measurement gaps (MGs) are configured, and only one measurement gap configured via PosGapConfig is activated. This requirement may guaranty that the MG configuration does not exceed the UEs capability of simultaneously supporting multiple MGs.

MG may be a static configuration with periodicity, duration, time, and location. Once configured, the UE may follow the configuration.

Furthermore, if the total activated measurement gaps allowed is less than [2 for per UE or 3 for per FR], the measurement gaps for each Rx hop can be a same one, which can be re-tuned to the different RX hops time to time. In other words, if the total activated measurement gaps allowed is 1 for per UE measurement gap, the measurement gap for all Rx hops is repetitions of the same measurement gap, which can be re-tuned to the different RX hops from time to time by the UE.
if the baseline capability for the UE is per UE, the UE may have one measurement gap configuration per UE;
if the UE support per measurement FR measurement gap, the UE may have up to two MGs, one per FR.

In further embodiments, if more activated measurement gaps are allowed [e.g., >3 for per UE or >4 for per FR], the measurement gaps for each Rx hop may be to a different measurement gap so the UE can support measurements within concurrent measurement gaps. In such embodiments, concurrent measurement gaps may be activated together within a specific duration larger than the duration of one or both of the individual measurement gaps.

### RSTD Measurements for RedCap

With respect to RSTD measurements for RedCap, the requirements in clause 9.9A.2 may apply provided the RedCap UE has received NR-DL-TDOA-RequestLocationInformation message from location management function (LMF) via LTE positioning protocol (LPP) requesting the RedCap UE to measure and report DL RSTD measurements defined in TS 38.215 (e.g., 3GPP TS 38.215 V17.4.0 (2023-12)). The requirements in clause 9.9A.2.5 may apply provided the RedCap UE does not support, or support but not configured, to measure PRS resources with Frequency Hopping (FH), subject to UE capability indicated. The requirements in clause 9.9A.2.6 may apply provided the RedCap UE supports and is configured to measure PRS resources with Frequency Hopping (FH), subject to UE capability indicated.

The requirements in clause 9.9A.2.6 may apply for periodic and triggered RSTD measurements with FH, provided:
PRS-RSTD related side conditions for 2 Rx RedCap UE given for FR1 and FR2 are fulfilled, for a corresponding Band. or
PRS-RSTD related side conditions for 1 Rx RedCap UE given for FR1 are fulfilled, for a corresponding Band.

A RedCap UE PRS RSTD measurement capability is as indicated by the RedCap UE in NR-DL-TDOA-ProvideCapabilities, according to TS 37.355 (e.g., 3GPP TS 37.355 V18.0.0 (2023-12)).

The requirements in TS 38.133 clause 9.9.2.4 may apply except for RSTD measurement accuracy. The RSTD measurements performed and reported according to this section may meet the RSTD measurement accuracy requirements for each measured DL PRS resource.

When physical layer receives last of NR-TDOA-ProvideAssistanceData message and NR-TDOA-RequestLocationInformation message from LMF via LPP, requesting RedCap UE to measure DL RSTD measurement with FH, the RedCap UE may be able to measure multiple (up to the RedCap UE capability specified in TS 38.133 clause 9.9A.2.3) DL RSTD measurements, defined in TS 38.215, during the measurement period T_{RSTD,Total} defined in TS 38.133 clause 9.9A.2.5.1 with using the following definition for Nₛₐₘₚₗₑ:
Nₛₐₘₚₗₑ is the number of PRS RSTD measurement samples, where:
   Nₛₐₘₚₗₑ=2 if the RedCap UE supports supportedDL-PRS-ProcessingSamples-RRC-CONNECTED, and the LMF requests the UE to perform positioning measurements with reduced number of samples.
   Nₛₐₘₚₗₑ=4 otherwise.

Measurement sample under FH is defined as a PRS measurement over multiple hops within a single measurement gap occasion.

The number of hops within a single MG occasion may be specified in TS 38.133 or other technical specification.

### PRS-RSRP Measurements for RedCap

For PRS-RSRP measurements for RedCap, the requirements in TS 38.133 clause 9.9A.3 may apply provided the RedCap UE has received a message from LMF via LPP requesting the RedCap UE to measure and report PRS-RSRP measurements defined in TS 38.215.

The requirements in TS 38.133 clause 9.9A.3.5 may apply provided the RedCap UE does not support, or support but not configured, to measure PRS resources with Frequency Hopping (FH), subject to UE capability indicated.

The requirements in TS 38.133 clause 9.9A.3.6 may apply provided the RedCap UE supports and is configured to measure PRS resources with Frequency Hopping (FH), subject to UE capability indicated.

The requirements in TS 38.133 clause 9.9A.3.6 may apply for periodic and triggered PRS-RSRP measurements with FH, provided:
PRS-RSRP related side conditions for 2 Rx RedCap UE given in TS 38.133 for FR1 and FR2 are met for a corresponding Band, or
PRS-RSRP related side conditions for 1 Rx RedCap UE given in TS 38.133 for FR1 are met for a corresponding Band.

UE PRS-RSRP measurement capability is as indicated by the UE in NR-DL-AoD-ProvideCapabilities according to TS 37.355.

The requirements in TS 38.133 clause 9.9.3.4 may apply except for PRS-RSRP measurement accuracy. The PRS-RSRP measurement accuracy for all measured PRS resources may be fulfilled according to the accuracy requirements specified in TS 38.133.

When the physical layer receives NR-DL-AoD-ProvideAssistanceData message and NR-DL-AoD-RequestLocationInformation message from LMF via LPP, requesting RedCap UE to measure PRS-RSRP measurement with FH, the RedCap UE may be able to measure multiple (up to the RedCap UE capability specified in TS 38.133 clause 9.9A.3.3) PRS-RSRP measurements, defined in TS 38.215, from configured PRS resources for configured transmission reference points (TRPs) on configured positioning frequency layers, within T_{PRS-RSRP,total} ms as defined TS 38.133 clause 9.9A.3.5.1 with using the following definition for Nₛₐₘₚₗₑ:
Nₛₐₘₚₗₑ is the number of PRS RSRP measurement samples, where:
   Nₛₐₘₚₗₑ=2 if the UE supports supportedDL-PRS-ProcessingSamples-RRC-CONNECTED, and the LMF requests the UE to perform positioning measurements with reduced number of samples.
Nₛₐₘₚₗₑ=4 otherwise.

Measurement sample under FH is defined as a PRS measurement over multiple hops within a single measurement gap occasion.

The number of hops within a single MG occasion may be specified in TS 38.133 or other technical specification.

### UE Rx-Tx Time Difference Measurements for RedCap

For UE Rx-Tx time difference measurements for RedCap, the requirements in this clause may apply for RedCap UE, when the UE received nr-Multi-RTT-RequestLocationInformation message from LMF via LPP requesting the UE to measure and report one or more UE Rx-Tx time difference measurements defined in TS 38.215 (e.g., 3GPP TS 38.215 V17.4.0 (2023-12)).

If UE does not support RX frequency hopping (FH) for PRS measurement as indicated by UE capability, or if LMF does not request UE to use RX FH for PRS measurement as indicated in the measurement request, the requirements in TS 38.133 clauses 9.9A.4.5, 9.9A.4.6 and 9.9A.4.7 may apply for applicable configurations.

If UE supports RX frequency hopping (FH) for PRS measurement as indicated by UE capability, and LMF requests UE to use RX FH for PRS measurement as indicated in the measurement request, the requirements in TS 38.133 clause 9.9A.4.8 may apply.

The requirements in TS 38.133 clause 9.9A.4 may apply for periodic and triggered UE Rx-Tx time difference measurements, provided:
UE Rx-Tx time difference measurement related side conditions given in TS 38.133 or other technical specification are met for a corresponding band.
SRS is configured on at least one of the PCell, PSCell and SCell.
The UE transmits SRS within [−160, 160] msec of at least one DL PRS resource of each of the TRPs in the assistance data.

The requirements in this clause may apply when a RedCap UE is request by the LMF to perform measurements with FH, and UE reports measurement based on multiple hops.

The requirements in clause 9.9A.4.5 may apply with the following modifications.
N_sample=2 if the UE supports the capability of positioning measurements with reduced number of samples as indicated as specified in TS 37.355, and the LMF requests the UE to perform positioning measurements with reduced number of samples.
Number of hops within a single MG occasion is defined in TS 38.133 or other technical specification.
Measurement sample under FH is defined as a PRS measurement over multiple hops within a single measurement gap.

### PRS-RSRPP Measurements for RedCap

For PRS-RSRPP measurements for RedCap, the requirements in this clause may apply for RedCap UE, when the UE received NR-DL-AoD-RequestLocationInformation message from LMF via LPP requesting the UE to measure and report one or more PRS-RSRPP measurements defined in TS 38.215.

If UE does not support frequency hopping (FH) for PRS measurement as indicated by UE capability, or if LMF does not request UE to use FH for PRS measurement as indicated in the measurement request, the requirements in TS 38.133 clauses 9.9A.5.5, 9.9A.5.6 and 9.9A.5.7 may apply for applicable configurations.

If UE supports frequency hopping (FH) for PRS measurement as indicated by UE capability, and LMF requests UE to use FH for PRS measurement as indicated in the measurement request, the requirements in TS 38.133 clause 9.9A.5.8 may apply.

The requirements in TS 38.133 clause 9.9A.5 may apply for periodic and triggered PRS-RSRPP measurements, provided:
PRS-RSRPP related side conditions given in TS 38.133 are met for a corresponding Band.

UE PRS-RSRPP measurement capability is as indicated by the UE in NR-DL-AoD-ProvideCapabilities according to TS 37.355.

This requirement assumes that the measurement report is not delayed by other LPP signaling on the dedicated control channel (DCCH). This measurement reporting delay excludes the delay uncertainty caused by inserting the measurement report into the transmission time interval (TTI) of the uplink DCCH. The delay uncertainty is: 2×TTIDCCH where TTIDCCH is the duration of subframe or slot or subslot when the measurement report is transmitted on the physical uplink control channel (PUSCH) with subframe or slot or subslot duration. This measurement reporting delay excludes any delay caused by no UL resources for UE to send the measurement report.

The reported PRS-RSRPP measurement values contained in measurement reports may be based on the measurement report mapping requirements specified in TS 38.133 clauses 10.1.38.3.

The PRS-RSRPP measurement accuracy for all measured PRS resources may be fulfilled according to the accuracy requirements specified in the TS 38.133 or other technical specification.

The measurement period requirements for PRS-RSRP defined in TS 38.133 clause 9.9A.3.5 may be re-used for PRS-RSRPP.

Various embodiments may be designed to address different technical problems associated with performing positioning measurements via a RedCap UE; defining measurement gaps for a RedCap UE; performing frequency hops by a UE to perform positioning measurements; configuring a UE for measurement gaps; limiting the number of concurrent measurement gaps of a UE; and/or the like.

Different technical problems such as those discussed above may be addressed by one or more different embodiments. Embodiments may address one or more of these problems associated with performing positioning measurements via a RedCap UE. For instance, some embodiments that address problems associated with performing positioning measurements via a RedCap UE may do so by one or more different technical means, such as, determining, based on a PRS configuration, a frequency range of a PRS, wherein the PRS configuration defines resource blocks of positioning frequency layers of the PRS; determining a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay; performing the number of frequency hops and measurements of the PRS during each of the repetitions of the one measurement gap or the up to two measurement gaps; causing transmission of at least one positioning measurement report via an interface; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3^{rd} Generation Partnership Project (3GPP), 3GPP Long Term Evolution (LTE), 3GPP LTE-Advanced (LTE-A), 4G LTE, 5G New Radio (NR) and/or 6G, technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-5220, IEEE 802.11ax-5221, IEEE 802.11ay-5221, IEEE 802.11ba-5221, and/or other specifications and standards, such as specifications developed by the Wi-Fi Alliance (WFA)

Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

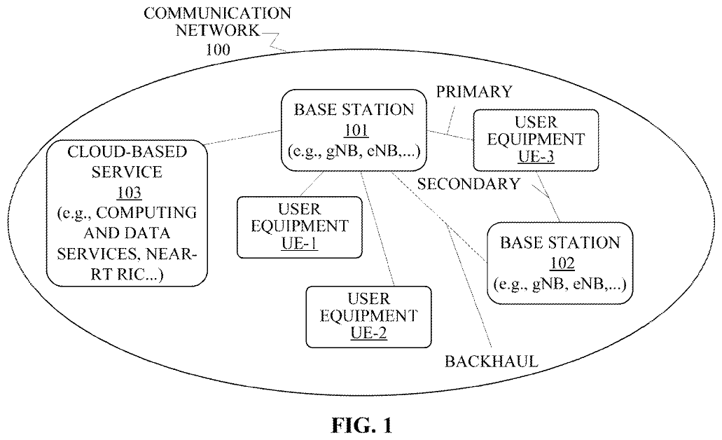

FIG. 1 illustrates a communication network 100 with user equipment (UE) such as UE-1, UE-2, and UE-3 and base stations such as base stations 101 and 102. The communication network 100 is an Orthogonal Frequency Division Multiplex (OFDM) network comprising a primary base station 101, a secondary base station 102, a cloud-based service 103, a first user equipment UE-1, a second user equipment UE-2, and a third user equipment UE-3. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, the backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture. For instance, the base station 101 may comprise a CU and the base station 102 may comprise a DU in some embodiments. In other embodiments, both the base stations 101 and 102 may comprise eNBs or gNBs.

The base stations 101 and 102 may communicate protocol data units (PDUs) via the backhaul. As an example, for the Xn interface, the base station 101 may transmit or share control plane PDUs via an Xn-C interface and may transmit or share data PDUs via a Xn-U interface. For the F1 interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the UEs such as UE-1 may comprise frequency hop logic circuitry to determine a series of one or more frequency hops between positioning frequency layers of a PRS to perform positioning measurements such as a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement. The frequency hops may advantageously allow the UE to measure a PRS with a larger bandwidth than the capability of the UE if the UE is, e.g., a RedCap UE.

In many embodiments, the UE is configured or preconfigured with one or two measurement gaps for positioning measurements such as one per UE measurement gap or up to two FR measurement gaps for FR1 and/or FR2. Based on the accuracy requirements for the positioning measurements, the measurement delay associated with each positioning measurement, and a delay for re-tuning a receiver for each frequency layer, the frequency hop logic circuitry may determine the number of frequency hops across the periodic measurement gaps that are required to meet the accuracy requirements for all the positioning measurements. In some embodiments, the number of frequency hops may be different between repetitions of the measurement gap to perform the positioning measurements. In other embodiments, the number of frequency hops may be the same between repetitions of the measurement gap to perform the positioning measurements.

In some embodiments, the base stations such as base station 101 and base station 102 may comprise frequency hop logic circuitry to configure the PRS for signaling with the measurement gap(s) configured for the UE. In many embodiments, the base stations may send a measurement gap configuration to the UE as well as configure the UE for one measurement gap per UE or up to two measurement gaps for per FR measurement gaps. In some embodiments, a location management function (LMF) may provide the measurement gap configuration to the UE via the base station via a LTE positioning protocol (LPP). In further embodiments, the different cellular network management function and/or protocol may provide the measurement gap configuration to the UE via the base station.

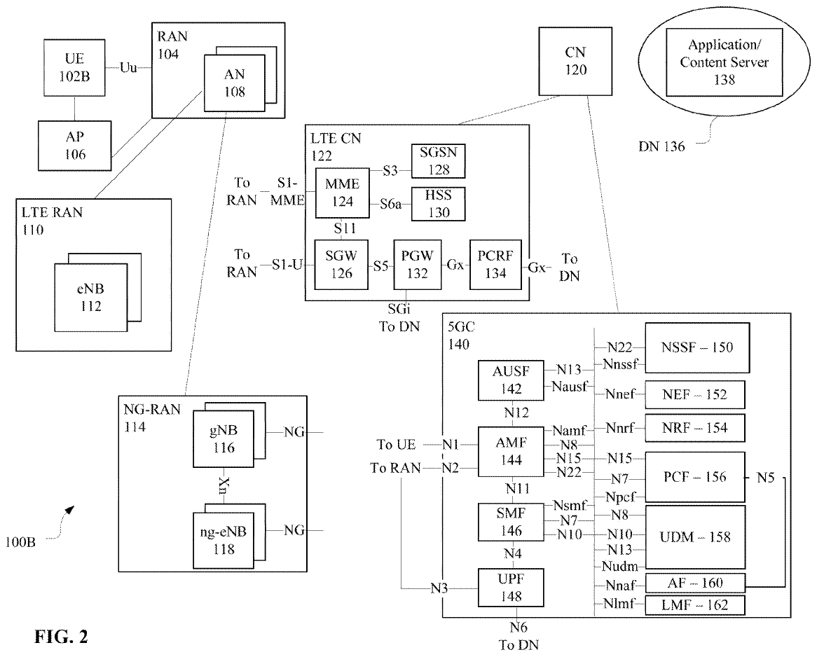

FIG. 2 illustrates an embodiment of a network 100B in accordance with various embodiments, such as the network 100 in FIG. 1. The network 100B may operate in a manner consistent with 3GPP technical specifications for LTE or 5G/NR systems as well as O-RAN specifications such as O-RAN “Near-Real-time RAN Intelligent Controller, E2 Service Model (E2SM), RAN Control”. However, the example embodiments are not limited in this regard and the described embodiments may apply to other networks that benefit from the principles described herein, such as future 3GPP systems, or the like.

The network 100B may include a UE 102B such as the UEs shown in FIG. 1, which may include any mobile or non-mobile computing device designed to communicate with a RAN 104 via an over-the-air connection. The UE 102B may be communicatively coupled with the RAN 104 by a Uu interface. The UE 102B may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100B may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102B may additionally communicate with an AP 106 via an over-the-air connection. The AP 106 may manage a WLAN connection, which may serve to offload some/all network traffic from the RAN 104. The connection between the UE 102B and the AP 106 may be consistent with any IEEE 802.11 protocol, wherein the AP 106 could be a wireless fidelity (Wi-Fi®) router. In some embodiments, the UE 102B, RAN 104, and AP 106 may utilize cellular-WLAN aggregation (for example, LWA/LWIP). Cellular-WLAN aggregation may involve the UE 102B being configured by the RAN 104 to utilize both cellular radio resources and WLAN resources.

The RAN 104 may include one or more access nodes, for example, AN 108. AN 108 may terminate air-interface protocols for the UE 102B by providing access stratum protocols including RRC, PDCP, RLC, MAC, and L1 protocols. In this manner, the AN 108 may enable data/voice connectivity between CN 120 and the UE 102B. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102B with an air interface for network access. The UE 102B may be simultaneously connected with a plurality of cells provided by the same or different ANs of the RAN 104. For example, the UE 102B and RAN 104 may use carrier aggregation to allow the UE 102B to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with Pcells/Scells. Prior to accessing the unlicensed spectrum, the nodes may perform medium/carrier-sensing operations based on, for example, a listen-before-talk (LBT) protocol.

In V2X scenarios the UE 102B or AN 108 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102B can be configured with multiple BWPs where each BWP configuration has a different SCS. When a BWP change is indicated to the UE 102B, the SCS of the transmission is changed as well. Another use case example of BWP is related to power saving. In particular, multiple BWPs can be configured for the UE 102B with different amount of frequency resources (for example, PRBs) to support data transmission under different traffic loading scenarios. A BWP containing a smaller number of PRBs can be used for data transmission with small traffic load while allowing power saving at the UE 102B and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102B). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102B to facilitate paging, bearer activation/deactivation, handovers, gateway selection, authentication, etc.

The SGW 126 may terminate an S1 interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102B and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an Sgi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the Sgi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, AF 160, and location management function (LMF) 162 coupled with one another over interfaces (or “reference points”) as shown. Functions of the elements of the 5GC 140 may be briefly introduced as follows.

The AUSF 142 may store data for authentication of UE 102B and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102B and the RAN 104 and to subscribe to notifications about mobility events with respect to the UE 102B. The AMF 144 may be responsible for registration management (for example, for registering UE 102B), connection management, reachability management, mobility management, lawful interception of AMF-related events, and access authentication and authorization. The AMF 144 may provide transport for SM messages between the UE 102B and the SMF 146, and act as a transparent proxy for routing SM messages. AMF 144 may also provide transport for SMS messages between UE 102B and an SMSF. AMF 144 may interact with the AUSF 142 and the UE 102B to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling and perform NAS ciphering and integrity protection. AMF 144 may also support NAS signaling with the UE 102B over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102B and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102B. The NSSF 150 may also determine allowed NSSAI and the mapping to the subscribed S-NSSAIs, if needed. The NSSF 150 may also determine the AMF set to be used to serve the UE 102B, or a list of candidate AMFs based on a suitable configuration and possibly by querying the NRF 154. The selection of a set of network slice instances for the UE 102B may be triggered by the AMF 144 with which the UE 102B is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102B. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102B) for the NEF 152. The Nudr service-based interface may be exhibited by the UDR 546 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3rd party services to be geographically close to a point that the UE 102B is attached to the network. This may reduce latency and load on the network. To provide edge-computing implementations, the 5GC 140 may select a UPF 148 close to the UE 102B and execute traffic steering from the UPF 148 to data network 136 via the N6 interface. This may be based on the UE subscription data, UE location, and information provided by the AF 160. In this way, the AF 160 may influence UPF (re) selection and traffic routing. Based on operator deployment, when AF 160 is considered to be a trusted entity, the network operator may permit AF 160 to interact directly with relevant NFs. Additionally, the AF 160 may exhibit a Naf service-based interface.

The LMF 162 is central in the 5G/6G positioning architecture. The LMF 162 receives measurements and assistance information from the next generation radio access network (NG-RAN) 114 and the UE 102B via the AMF 160 over the NLs interface to compute the position of the UE 102B. Due to the new next generation interface between the NG-RAN and the CN 120, a NR positioning protocol A (NRPPa) protocol may carry the positioning information between NG-RAN 114 and LMF 162 over the next generation control plane interface (NG-C). The LMF 162 may configure the UE 102B using the LTE positioning protocol (LPP) via the AMF 144. The NG RAN 114 may configure the UE 102B using RRC protocol over LTE-Uu and NR-Uu.

The data network 136 may represent various network operator services, Internet access, or third-party services that may be provided by one or more servers including, for example, application/content server 138.

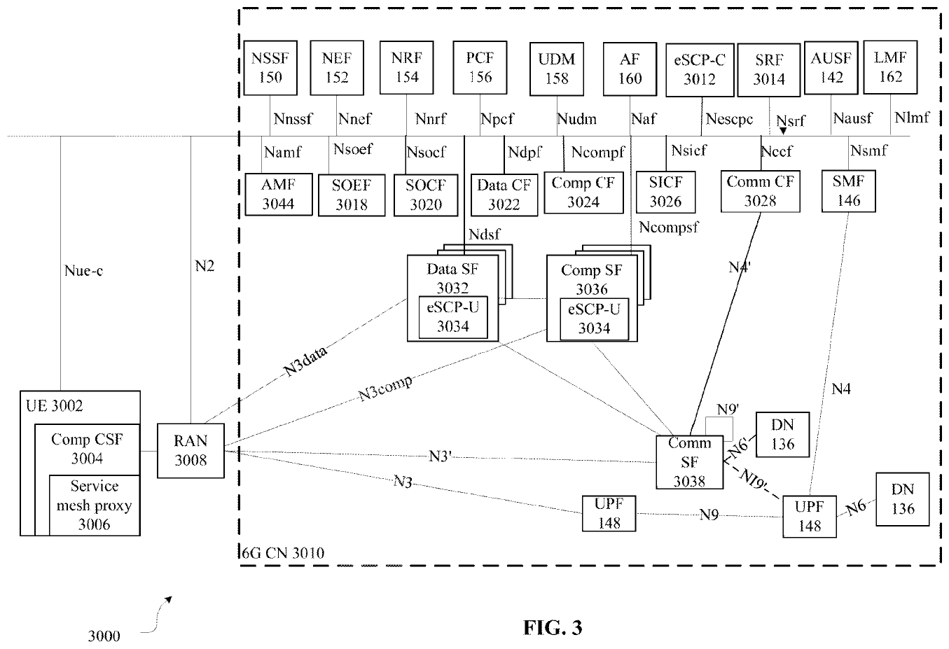

FIG. 3 illustrates an embodiment of a network 3000 such as the communication network 100 shown in FIGS. 1 and 100B shown in FIG. 2, in accordance with various embodiments. The network 3000 may operate in a matter consistent with 3GPP technical specifications or technical reports for 6G systems. In some embodiments, the network 3000 may operate concurrently with network 100B. For example, in some embodiments, the network 3000 may share one or more frequency or bandwidth resources with network 100B. As one specific example, a UE (e.g., UE 3002) may be configured to operate in both network 3000 and network 100B. Such configuration may be based on a UE including circuitry configured for communication with frequency and bandwidth resources of both networks 100B and 3000. In general, several elements of network 3000 may share one or more characteristics with elements of network 100B. For the sake of brevity and clarity, such elements may not be repeated in the description of network 3000.

The network 3000 may include a UE 3002, which may include any mobile or non-mobile computing device designed to communicate with a RAN 3008 via an over-the-air connection. The UE 3002 may be similar to, for example, UE 102B. The UE 3002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 3, in some embodiments the network 3000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 3, the UE 3002 may be communicatively coupled with an AP such as AP 106 as described with respect to FIG. 2. Additionally, although not specifically shown in FIG. 3, in some embodiments the RAN 3008 may include one or more ANs such as AN 108 as described with respect to FIG. 2. The RAN 3008 and/or the AN of the RAN 3008 may be referred to as a base station (BS), a RAN node, or using some other term or name.

The UE 3002 and the RAN 3008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 3008 may allow for communication between the UE 3002 and a 6G core network (CN) 3010. Specifically, the RAN 3008 may facilitate the transmission and reception of data between the UE 3002 and the 6G CN 3010. The 6G CN 3010 may include various functions such as NSSF 150, NEF 152, NRF 154, PCF 156, UDM 158, AF 160, SMF 146, AUSF 142, and LMF 162. The 6G CN 3010 may additional include UPF 148 and DN 136 as shown in FIG. 3.

Additionally, the RAN 3008 may include various additional functions that are in addition to, or alternative to, functions of a legacy cellular network such as a 4G or 5G network. Two such functions may include a Compute Control Function (Comp CF) 3024 and a Compute Service Function (Comp SF) 3036. The Comp CF 3024 and the Comp SF 3036 may be parts or functions of the Computing Service Plane. Comp CF 3024 may be a control plane function that provides functionalities such as management of the Comp SF 3036, computing task context generation and management (e.g., create, read, modify, delete), interaction with the underlaying computing infrastructure for computing resource management, etc. Comp SF 3036 may be a user plane function that serves as the gateway to interface computing service users (such as UE 3002) and computing nodes behind a Comp SF instance. Some functionalities of the Comp SF 3036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 3036 instance may serve as the user plane gateway for a cluster of computing nodes. A Comp CF 3024 instance may control one or more Comp SF 3036 instances.

Two other such functions may include a Communication Control Function (Comm CF) 3028 and a Communication Service Function (Comm SF) 3038, which may be parts of the Communication Service Plane. The Comm CF 3028 may be the control plane function for managing the Comm SF 3038, communication sessions creation/configuration/releasing, and managing communication session context. The Comm SF 3038 may be a user plane function for data transport. Comm CF 3028 and Comm SF 3038 may be considered as upgrades of SMF 146 and UPF 148, which were described with respect to a 5G system in FIG. 1B. The upgrades provided by the Comm CF 3028 and the Comm SF 3038 may enable service-aware transport. For legacy (e.g., 4G or 5G) data transport, SMF 146 and UPF 148 may still be used.

Two other such functions may include a Data Control Function (Data CF) 3022 and Data Service Function (Data SF) 3032 may be parts of the Data Service Plane. Data CF 3022 may be a control plane function and provides functionalities such as Data SF 3032 management, Data service creation/configuration/releasing, Data service context management, etc. Data SF 3032 may be a user plane function and serve as the gateway between data service users (such as UE 3002 and the various functions of the 6G CN 3010) and data service endpoints behind the gateway. Specific functionalities may include parse data service user data and forward to corresponding data service endpoints, generate charging data, and report data service status.

Another such function may be the Service Orchestration and Chaining Function (SOCF) 3020, which may discover, orchestrate and chain up communication/computing/data services provided by functions in the network. Upon receiving service requests from users, SOCF 3020 may interact with one or more of Comp CF 3024, Comm CF 3028, and Data CF 3022 to identify Comp SF 3036, Comm SF 3038, and Data SF 3032 instances, configure service resources, and generate the service chain, which could contain multiple Comp SF 3036, Comm SF 3038, and Data SF 3032 instances and their associated computing endpoints. Workload processing and data movement may then be conducted within the generated service chain. The SOCF 3020 may also be responsible for maintaining, updating, and releasing a created service chain.

Another such function may be the service registration function (SRF) 3014, which may act as a registry for system services provided in the user plane such as services provided by service endpoints behind Comp SF 3036 and Data SF 3032 gateways and services provided by the UE 3002. The SRF 3014 may be considered a counterpart of NRF 154, which may act as the registry for network functions.

Other such functions may include an evolved service communication proxy (eSCP) and service infrastructure control function (SICF) 3026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 3012 and eSCP-U 3034, for control plane service communication proxy and user plane service communication proxy, respectively. The SICF 3026 may control and configure cCSP instances in terms of service traffic routing policies, access rules, load balancing configurations, performance monitoring, etc.

Another such function is the AMF 3044. The AMF 3044 may be similar to 144, but with additional functionality. Specifically, the AMF 3044 may include potential functional repartition, such as move the message forwarding functionality from the AMF 3044 to the RAN 3008.

Another such function is the service orchestration exposure function (SOEF) 3018. The SOEF may be configured to expose service orchestration and chaining services to external users such as applications.

The UE 3002 may include an additional function that is referred to as a computing client service function (comp CSF) 3004. The comp CSF 3004 may have both the control plane functionalities and user plane functionalities, and may interact with corresponding network side functions such as SOCF 3020, Comp CF 3024, Comp SF 3036, Data CF 3022, and/or Data SF 3032 for service discovery, request/response, compute task workload exchange, etc. The Comp CSF 3004 may also work with network side functions to decide on whether a computing task should be run on the UE 3002, the RAN 3008, and/or an element of the 6G CN 3010.

The UE 3002 and/or the Comp CSF 3004 may include a service mesh proxy 3006. The service mesh proxy 3006 may act as a proxy for service-to-service communication in the user plane. Capabilities of the service mesh proxy 3006 may include one or more of addressing, security, load balancing, etc.

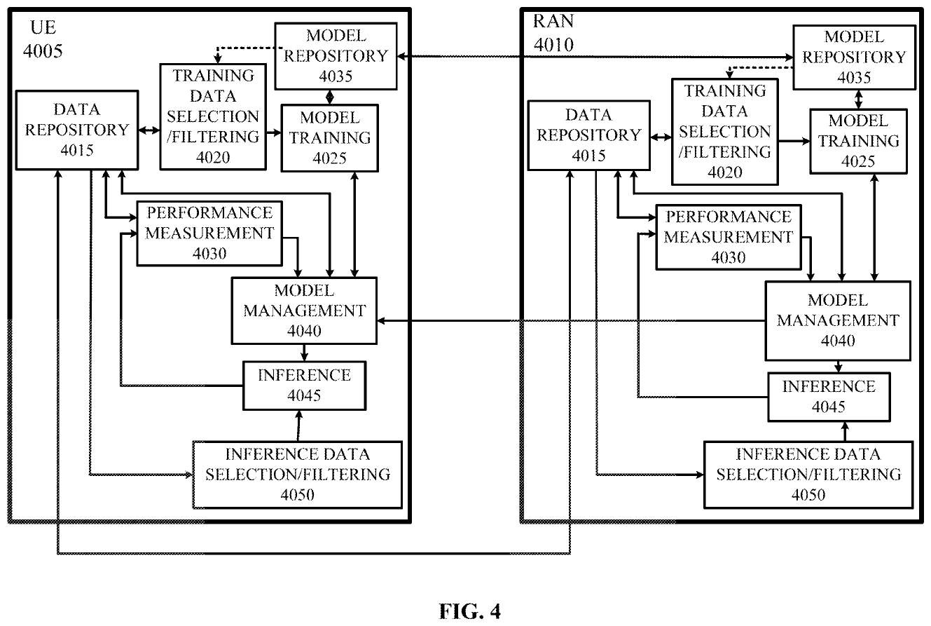

FIG. 4 illustrates an embodiment of a simplified block diagram of artificial (AI)-assisted communication between a UE 4005 and a RAN 4010, in accordance with various embodiments. More specifically, as described in further detail below, AI/machine learning (ML) models may be used or leveraged to facilitate over-the-air communication between UE 4005 and RAN 4010.

One or both of the UE 4005 and the RAN 4010 may operate in a matter consistent with 3GPP technical specifications or technical reports for 6G systems. In some embodiments, the wireless cellular communication between the UE 4005 and the RAN 4010 may be part of, or operate concurrently with, networks 3000, 100B, and/or some other network described herein.

The UE 4005 may be similar to, and share one or more features with, UE 3002, UE 102B, and/or some other UE described herein. The UE 4005 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 4010 may be similar to, and share one or more features with, RAN 114, RAN 3008, and/or some other RAN described herein.

As may be seen in FIG. 4, the AI-related elements of UE 4005 may be similar to the AI-related elements of RAN 4010. For the sake of discussion herein, description of the various elements will be provided from the point of view of the UE 4005, however it will be understood that such discussion or description will apply to equally named/numbered elements of RAN 4010, unless explicitly stated otherwise.

As previously noted, the UE 4005 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 4015. The data repository 4015 may be responsible for data collection and storage. Specifically, the data repository 4015 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 4015. For example, as may be seen, the inference data selection/filter element 4050 may retrieve data from the data repository 4015. In various embodiments, the UE 4005 may be configured to discover and request data from the data repository 4010 in the RAN, and vice versa. More generally, the data repository 4015 of the UE 4005 may be communicatively coupled with the data repository 4015 of the RAN 4010 such that the respective data repositories of the UE and the RAN may share collected data with one another.

Another such element may be a training data selection/filtering functional block 4020. The training data selection/filter functional block 4020 may be configured to generate training, validation, and testing datasets for model training. Training data may be extracted from the data repository 4015. Data may be selected/filtered based on the specific AI/ML model to be trained. Data may optionally be transformed/augmented/pre-processed (e.g., normalized) before being loaded into datasets. The training data selection/filter functional block 4020 may label data in datasets for supervised learning. The produced datasets may then be fed into model training the model training functional block 4025.

As noted above, another such element may be the model training functional block 4025. This functional block may be responsible for training and updating (re-training) AI/ML models such as encoder NNs and decoder NNs discussed in conjunction with other FIGs. herein. The selected model may be trained using the fed-in datasets (including training, validation, testing) from the training data selection/filtering functional block. The model training functional block 4025 may produce trained and tested AI/ML models which are ready for deployment. The produced trained and tested models can be stored in a model repository 4035.

The model repository 4035 may be responsible for AI/ML models' (both trained and un-trained) storage and exposure. Trained/updated model(s) may be stored into the model repository 4035. Model and model parameters may be discovered and requested by other functional blocks (e.g., the training data selection/filter functional block 4020 and/or the model training functional block 4025). In some embodiments, the UE 4005 may discover and request AI/ML models from the model repository 4035 of the RAN 4010. Similarly, the RAN 4010 may be able to discover and/or request AI/ML models from the model repository 4035 of the UE 4005. In some embodiments, the RAN 4010 may configure models and/or model parameters in the model repository 4035 of the UE 4005.

Another such element may be a model management functional block 4040. The model management functional block 4040 may be responsible for management of the AI/ML model produced by the model training functional block 4025. Such management functions may include deployment of a trained model, monitoring model performance, etc. In model deployment, the model management functional block 4040 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 4040 may decide to terminate the running model, start model re-training, select another model, etc. In embodiments, the model management functional block 4040 of the RAN 4010 may be able to configure model management policies in the UE 4005 as shown.

Another such element may be an inference data selection/filtering functional block 4050. The inference data selection/filter functional block 4050 may be responsible for generating datasets for model inference at the inference functional block 4045, as described below. Specifically, inference data may be extracted from the data repository 4015. The inference data selection/filter functional block 4050 may select and/or filter the data based on the deployed AI/ML model. Data may be transformed/augmented/pre-processed following the same transformation/augmentation/pre-processing as those in training data selection/filtering as described with respect to functional block 4020. The produced inference dataset may be fed into the inference functional block 4045.

Another such element may be the inference functional block 4045. The inference functional block 4045 may be responsible for executing inference as described above. Specifically, the inference functional block 4045 may consume the inference dataset provided by the inference data selection/filtering functional block 4050, and generate one or more outcomes. Such outcomes may be or include data analytics, actions, policies, etc. The outcome(s) may be provided to the performance measurement functional block 4030.

The performance measurement functional block 4030 may be configured to measure model performance metrics (e.g., accuracy, model bias, run-time latency, etc.) of deployed and executing models based on the inference outcome(s) for monitoring purpose. Model performance data may be stored in the data repository 4015.

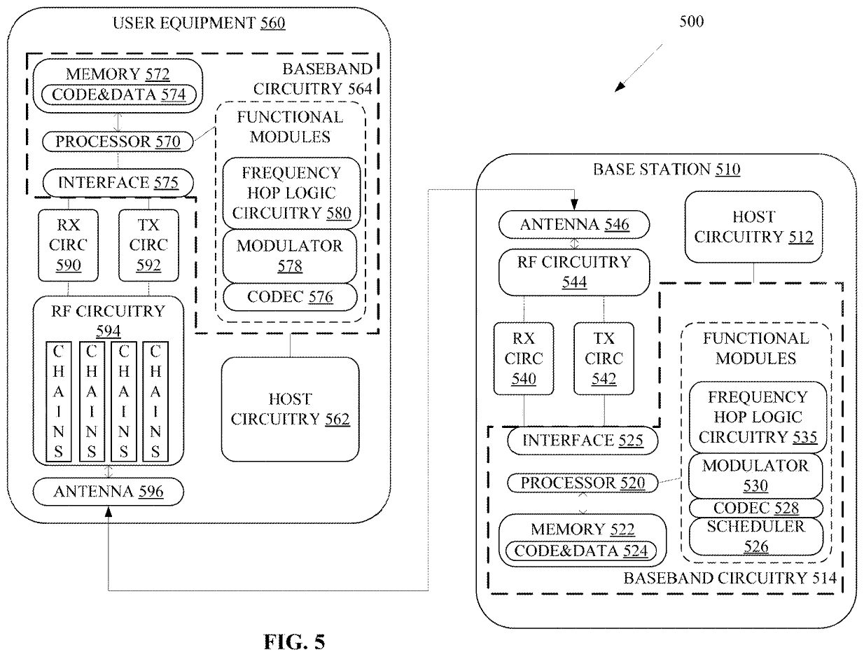

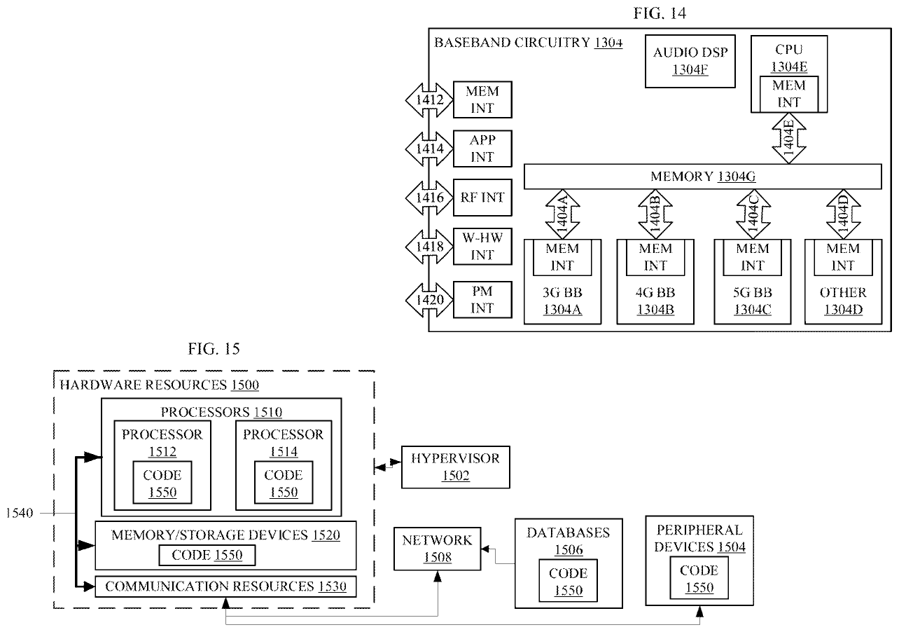

FIG. 5 is an embodiment of a simplified block diagram 500 of a base station 501 and a user equipment (UE) 511 that may carry out certain embodiments in a communication network such as the base stations or RANs, the UEs, and communication networks shown in FIGS. 1-4. For the base station 510, the antenna 546 transmits and receives radio signals. The RF circuitry 544 coupled with the antenna 546, which is the physical layer of the base station 510, receives RF signals from the antenna 546 and performs operations on the signals such as amplifying signals, and splitting the signals into quadrature phase and in-phase signals. The receiver circuitry 590 may convert the signals to digital baseband signals, or uplink data, and pass the digital in-phase and quadrature phase signals to the processor 520 of the baseband circuitry 514, also referred to as the processing circuitry or baseband processing circuitry, via an interface 525 (e.g., RF interface 1416 shown in FIG. 14) of the baseband circuitry 514 for communications such as an interface for network communications with UEs, an interface for network communications with a core cellular network such as a 5G core, an interface for network communications with other base stations, or an interface for other related network communications. In other embodiments, analog to digital converters of the processor 520 may convert the in-phase and quadrature phase signals to digital baseband signals.

The transmitter circuitry 592 may convert received, digital baseband signals, or downlink data, from the processor 520 to analog signals. The RF circuitry 544 processes and amplifies the analog signals and converts the analog signals to RF signals and passes the amplified, analog RF signals out to antenna 546.

The processor 520 decodes and processes the digital baseband signals, or uplink data, and invokes different functional modules to perform features in the base station 510. The memory 522 stores program instructions or code and data 524 to control the operations of the base station 510. The host circuitry 512 may execute code such as RRC layer code from the code and data 524 to implement RRC layer functionality and code. Note that code executed above the medium access control (MAC) layer and physical layer (PHY) is often referred to as higher layer code. A similar configuration exists in UE 560 where the antenna 596 transmits and receives RF signals. The RF circuitry 594, coupled with the antenna 596, receives RF signals from the antenna 596, amplifies the RF signals, and processes the signals to generate analog in-phase and quadrature phase signals. The receiver circuitry 590 processes and converts the analog in-phase and quadrature phase signals to digital baseband signals via an analog to digital converter, or downlink data, and passes the in-phase and quadrature phase signals to processor 570 of the baseband circuitry 564 via an interface 575 (e.g., RF interface 1416 shown in FIG. 14) of the baseband circuitry 564 for communications such as an interface for network communications with other UEs, an interface for network communications with base stations, or an interface for other related network communications. In other embodiments, the processor 570 may comprise analog to digital converters to convert the analog in-phase and quadrature phase signals to digital in-phase and quadrature phase signals.

The transmitter circuitry 592 may convert received, digital baseband signals, or downlink data, from the processor 570 to analog signals. The RF circuitry 594 processes and amplifies the analog signals and converts the analog signals to RF signals and passes the amplified, analog RF signals out to antenna 596.

The RF circuitry 594 illustrates multiple RF chains. While the RF circuitry 594 illustrates four RF chains, each UE may have a different number of RF chains such as 8 RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 594 may include transmitter circuitry and receiver circuitry, which is often called transceiver circuitry. The transmitter circuitry may prepare digital data from the processor 570 for transmission through the antenna 596. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 570 decodes and processes the digital baseband signals, or downlink data, and invokes different functional modules to perform features in the UE 560. The memory 572 stores program instructions or code and data 574 to control the operations of the UE 560. The processor 570 may also execute medium access control (MAC) layer code of the code and data 574 for the UE 560. For instance, the MAC layer code may execute on the processor 570 to cause UL communications to transmit to the base station 510 via one or more of the RF chains of the physical layer (PHY). The PHY is the RF circuitry 594 and associated logic such as some or all the functional modules.

The host circuitry 562 may execute code such as RRC layer code to implement RRC layer functionality and code or RRM layer code to implement RRM layer functionality. In some embodiments, the RRC layer code may be the higher layer code that provides configuration information to the frequency hop logic circuitry 535 and 580 of the base station 510 and the UE 560, respectively, via higher layer signaling. The configuration information provided by the higher layer may comprise parameters such as the transmission mode (txConfig), PUSCH configuration (puschconfig), dmrs-Type, maxLength, and the number of codewords.

The base station 510 and the UE 560 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 520 (e.g., via executing program code 524) is a functional block to configure and implement the circuitry of the functional modules to allow the base station 510 to schedule (via scheduler 526), encode or decode (via codec 528), modulate or demodulate (via modulator 530), and transmit data to or receive data from the UE 560 via the RF circuitry 544 and the antenna 546.

The processor 570 (e.g., via executing program code in the code and data 574) may be a functional block to configure and implement the circuitry of the functional modules to allow the UE 560 to receive or transmit, de-modulate or modulate (via de-modulator 578), and decode or encode (via codec 576) data accordingly via the RF circuitry 594 and the antenna 596.

The base station 510 may also include a functional module, frequency hop logic circuitry 535. The frequency hop logic circuitry 535 of the base station 510 may communicate with the LMF via LPP to determine one or more positioning measurement configurations for the UE 560 for positioning measurements. In some embodiments, other cellular management functions and/or protocols may provide positioning measurement configurations to the base station 510 for the UE 560 for positioning measurements. For instance, in some embodiments, the LMF may determine to assign the UE 560 with a per UE measurement gap configuration for positioning measurements. In some embodiments, the LMF may determine to assign the UE 560 with a per FR measurement gap configuration for positioning measurements and assign a per FR1 measurement gap, a per FR2 measurement gap, or both a per FR1 measurement gap and a per FR2 measurement gap to the UE 560. In many embodiments, the LMF, frequency hop logic circuitry 535 of the base station 510, or another network component may configure or preconfigure the UE 560 with a positioning measurement gap configuration to identify time and frequency resources (RBs) for one or more measurement gaps.

In many embodiments, the LMF, frequency hop logic circuitry 535 of the base station 510, or another network component may also configure a PRS for transmit during the repetitions of the measurement gaps. In many embodiments, the PRS is configured to be available for measurement throughout measurement gaps of the UE 560 so that the UE 560 can determine timing for the frequency hops throughout each repetition of the measurement gaps to perform the positioning measurements.

The UE 560 may also include a functional module, frequency hop logic circuitry 580. The frequency hop logic circuitry 580 of the UE 560 may cause the processor 570 and/or the host circuitry 562 to receive one or more configurations for positioning measurements, store the one or more configurations in the memory 572, and access the one or more configurations to perform positioning measurements of one or more measurement types such as a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement. The frequency hop logic circuitry 580 of the UE 560 may perform the positioning measurements based on accuracy requirements and measurement delays corresponding to the measurement types. To increase the accuracy of a positioning measurement, the UE 560 may perform more measurements of the PRS within the corresponding measurement delay.

To perform the positioning measurements, the frequency hop logic circuitry 580 of the UE 560 may determine a series of two or more frequency hops between positioning frequency layers of the PRS within measurement gap repetitions. Each frequency hop may involve re-tuning a receiver of the UE so the determination of the number of frequency hops may also account for a delay involved with re-tuning.

In many embodiments, may overlap RBs of the positioning frequency layers to account for phase differences between measurements of different positioning frequency layers during the measurement gaps. For instance, if the UE is configured or preconfigured for a per UE measurement gap, the frequency hop logic circuitry 580 of the UE 560 may determine a number of frequency hops to perform the RSTD measurement, the PRS-RSRP measurement, the UE Rx-TX time difference measurement, and the PRS-RSRPP measurement such that positioning measurement report for each measurement type can be transmitted to the base station 560 within a corresponding measurement delay. The measurement delay may be defined as a number of repetitions of the measurement gap repetition period (MGRP) and may be defined differently for each of the different measurement types. In some embodiments, the maximum measurement delay for each of the different measurement types is four repetitions of the measurement gaps or four MGRPs.

In many embodiments, the frequency hop logic circuitry 580 of the UE 560 may generate and cause transmission of a positioning measurement report to the base station 510 for each of the measurement types such as the RSTD measurement, the PRS-RSRP measurement, the UE Rx-TX time difference measurement, and the PRS-RSRPP measurement.

FIG. 6 depicts an embodiment of a table 600 for gap combination configuration identifiers (IDs) for identifying per UE or per FR measurement gap patterns to frequency hop logic circuitry of a UE such as the embodiments described in conjunction with FIGS. 1-5. The table 600 illustrates the number of Gap Combination Configurations by UEs supporting both concurrent measurement gap patterns and independent measurement gap patterns.

If the UE requires measurement gaps to identify and measure intra-frequency cells and/or inter-frequency cells and/or inter-RAT E-UTRAN cells, and the UE supports concurrentPerUE-OnlyMeasGap-r17 as specified, in order for the requirements to apply, the cellular network can provide at most two per-UE measurement gap patterns (MGPs) for monitoring of all frequency layers.

If the UE requires measurement gaps to identify and measure intra-frequency cells and/or inter-frequency cells and/or inter-RAT E-UTRAN cells, and the UE supports concurrentPerUE-PerFRCombMeasGap-r17 as specified, in order for the requirements defined for concurrent measurement gaps to apply, the cellular network can provide the MGP combinations specified in table 600 for monitoring of all frequency layers.

If the UE is not capable of concurrentMeasGapEUTRA-r17, all E-UTRAN measurement objects are expected to be associated with a single concurrent MGP. When UE supports concurrent measurement gap patterns and configured with more than 1 measurement gap pattern Per FR or Per-UE according to table 600, requirements does not apply if the UE is configured with more than one MGP with measurement gap repetition period (MGRP) of 20 milliseconds (ms) in a FR.

The table 600 includes a column for gap combination configuration IDs and a column for simultaneous measurement gap patterns. The column for simultaneous measurement gap patterns may comprise three sub-columns to identify a pattern for per FR1 measurement gap, for per FR2 measurement gap, and per UE measurement gap.

Each row, such as rows 610, 620, and 630, identifies measurement gap patterns for a particular gap combination configuration ID. For example, row 610 identifics gap combination configuration ID 3 as having one measurement gap in FR1 if the UE is configured for a per FR measurement gap or having one measurement gap if the UE is configured for a per UE measurement gap. Row 620 identifies gap combination configuration ID 4 as having one measurement gap in FR2 if the UE is configured for a per FR measurement gap or having one measurement gap if the UE is configured for a per UE measurement gap. Row 6300 identifies gap combination configuration ID 5 as having one measurement gap in FR1 and one measurement gap in FR2 if the UE is configured for a per FR measurement gap or having one measurement gap if the UE is configured for a per UE measurement gap.

FIG. 7 depicts a flowchart 700 of an embodiment for frequency hop logic circuitry of a user equipment to perform frequency hops between positioning frequency layers for measurements related to positioning such as the embodiments described in conjunction with FIGS. 1-6. The flowchart 700 begins with frequency hop logic circuitry of a UE of a cellular network determines, based on a PRS configuration, a frequency range of a PRS, wherein the PRS configuration defines resource blocks of positioning frequency layers of the PRS (element 710). The UE may be configured or preconfigured with a measurement gap configuration for performing positioning measurements for measurement types such as a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement.

The DL RSTD is the DL relative timing difference between the Transmission Point (TP) j and the reference TP i, defined as T_{SubframeRxj}−T_{SubframeRxi},

Where:

T_{SubframeRxj} is the time when the UE receives the start of one subframe from TP j.

T_{SubframeRxi} is the time when the UE receives the corresponding start of one subframe from TP i that is closest in time to the subframe received from TP j.

Multiple DL PRS resources can be used to determine the start of one subframe from a TP. For frequency range 1 (FR1), the reference point for the DL RSTD may be the antenna connector of the UE. For frequency range 2 (FR2), the reference point for the DL RSTD may be the antenna of the UE.

The DL PRS reference signal received power (DL PRS-RSRP) is defined as the linear average over the power contributions (in [Watts]) of the resource elements that carry DL PRS reference signals configured for RSRP measurements within the considered measurement frequency bandwidth.

For frequency range 1 (FR1), the reference point for the DL PRS-RSRP may be the antenna connector of the UE. For frequency range 2 (FR2), DL PRS-RSRP may be measured based on the combined signal from antenna elements corresponding to a given receiver branch. For frequency range 1 and 2 (FR1 and FR2), if receiver diversity is in use by the UE, the reported DL PRS-RSRP value may not be lower than the corresponding DL PRS-RSRP of any of the individual receiver branches.

The UE Rx-Tx time difference is defined as T_{UE-RX}-T_{UE-TX}

Where:

T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or channel state information-reference signal (CSI-RS) for tracking resources, as instructed by higher layers, can be used to determine the start of one subframe of the first arrival path of the TP.

For frequency range 1 (FR1), the reference point for T_{UE-RX} measurement may be the Rx antenna connector of the UE and the reference point for T_{UE-TX} measurement may be the Tx antenna connector of the UE. For frequency range 2 (FR2), the reference point for T_{UE-RX} measurement may be the Rx antenna of the UE and the reference point for T_{UE-TX} measurement may be the Tx antenna of the UE.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time.

For frequency range 1 (FR1), the reference point for the DL PRS-RSRPP may be the antenna connector of the UE. For frequency range 2 (FR2), DL PRS-RSRPP may be measured based on the combined signal from antenna elements corresponding to a given receiver branch.

For frequency range 1 and 2 (FR1 and FR2), if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements.

At element 715, the frequency hop logic circuitry of a UE determines a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay. Each of the frequency layers associated with the number of frequency hops during a repetition of one measurement gap or the up to two measurement gaps may be associated with a different bandwidth part of the PRS.

In many embodiments, the BW parts of the PRS may be overlapping so that the frequency hop logic circuitry of a UE may adjust the measurement for phase differences via the overlapping RBs. In some embodiments, the UE is configured with the positioning measurement gap via a base station such as a gNB by a location management function (LMF) of a core network. The positioning measurement gap configuration may reside in the memory of the UE. In further embodiments, another cellular network component may configure or preconfigure the UE with a positioning measurement gap.

In many embodiments, the positioning measurement gap configuration is associated as a per UE positioning measurement gap configuration or a per FR positioning measurement gap configuration. In some embodiments, the selection of the per UE positioning measurement gap configuration or a per FR positioning measurement gap configuration is based on the capabilities of the UE. In further embodiments, the selection of the per UE positioning measurement gap configuration or a per FR positioning measurement gap configuration is determined by the cellular network.

For per UE positioning measurement gap configuration, the UE may be configured with one measurement gap having a periodicity of a measurement gap repetition period (MGRP) and the frequency hop logic circuitry of a UE may determine the number of frequency hops for each repetition of the measurement gap based on performing measurements for positioning within a measurement delay. A different measurement delay may be established for each of the different positioning measurement types or may all be the same measurement delay. In many embodiments, the measurement delay may be defined as a number of repetitions of the measurement gap.

For per FR positioning measurement gap configuration, the UE may be configured with one measurement gap per FR (e.g., one MG for FR1, one MG for FR2, or one MG for FR1 and one MG for FR2). Each of the per FR measurement gaps may have a periodicity of a measurement gap repetition period (MGRP) and the frequency hop logic circuitry of a UE may determine the number of frequency hops for each repetition of the measurement gap for each FR based on performing measurements for positioning within a measurement delay for each FR.

At element 720, the frequency hop logic circuitry of a UE may perform the number of frequency hops and measurements of the PRS during each of the repetitions of the one measurement gap for per UE or the up to two measurement gaps for per FR measurement gap configurations. In many embodiments, for per UE, all positioning frequency layers are measured or associated with only one per-UE measurement gap. In many embodiments, for per FR, all positioning frequency layers in a same FR are measured or associated with only one per-FR measurement gap in a corresponding FR.

At element 725, the frequency hop logic circuitry of a UE may cause transmission of at least one positioning measurement report via an interface. In many embodiments, the measurement delay is defined per measurement type (RSTD, PRS-RSRP, UE Rx-TX time difference, and PRS-RSRPP) and comprises a maximum of four repetitions of the one measurement gap per UE or the up to two measurement gaps per FR. The frequency hop logic circuitry of a UE may cause transmission of each of a positioning measurement report for each of the measurement type within a corresponding measurement delay for the measurement type.

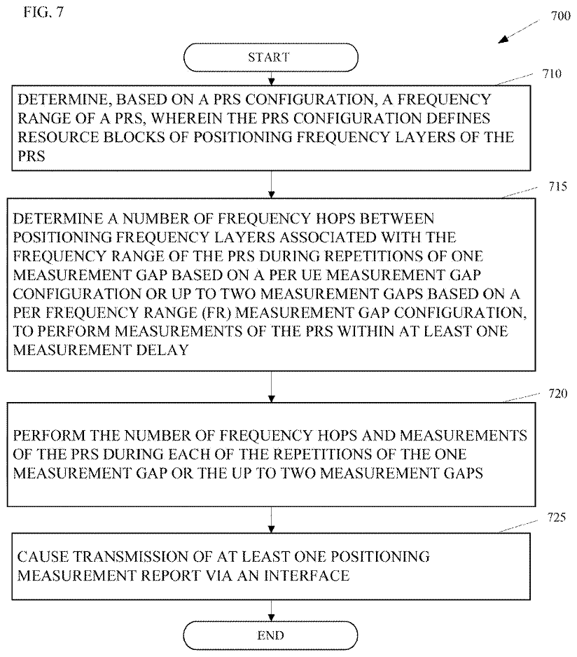

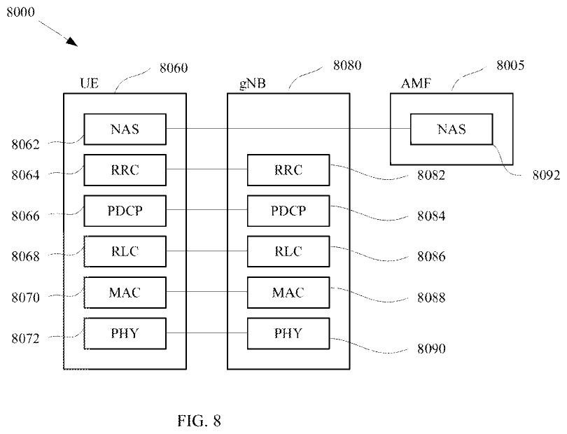

FIG. 8 depicts an embodiment of protocol entities 8000 that may be implemented in wireless communication devices discussed in conjunction with other FIGs. herein, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects. In further embodiments, the NodeB may comprise an xNodeB for a 6^{th} generation or later NodeB.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

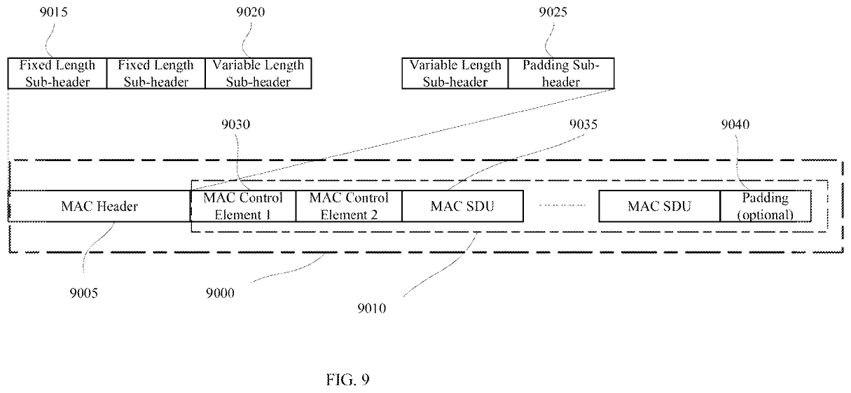

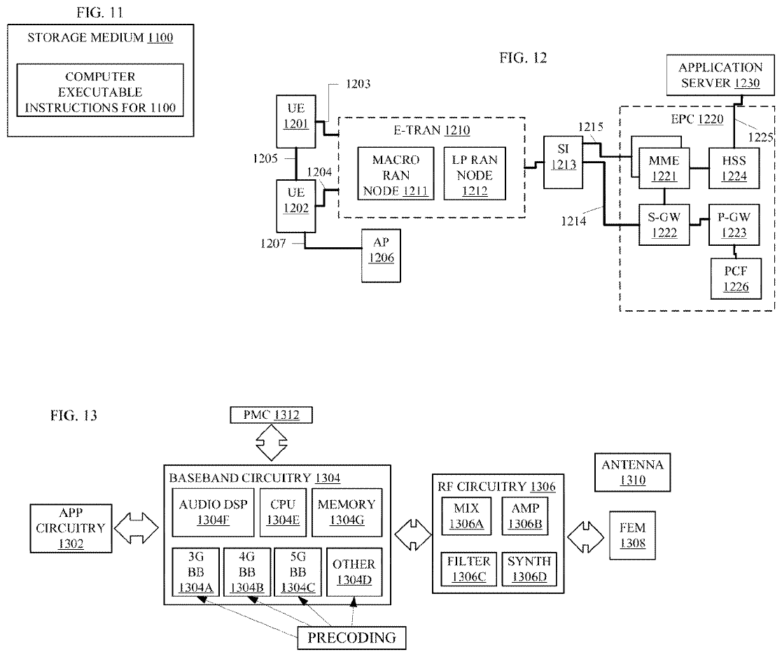

FIG. 9 illustrates embodiments of the formats of PHY data units (PDUs) that may be transmitted by the PHY device via one or more antennas and be encoded and decoded by a MAC entity such as the processors 520 and 570 discussed in conjunction with FIG. 5, the baseband circuitry 1304 discussed in conjunction with FIGS. 13 and 14, and/or discussed in conjunction with other FIGs. herein. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

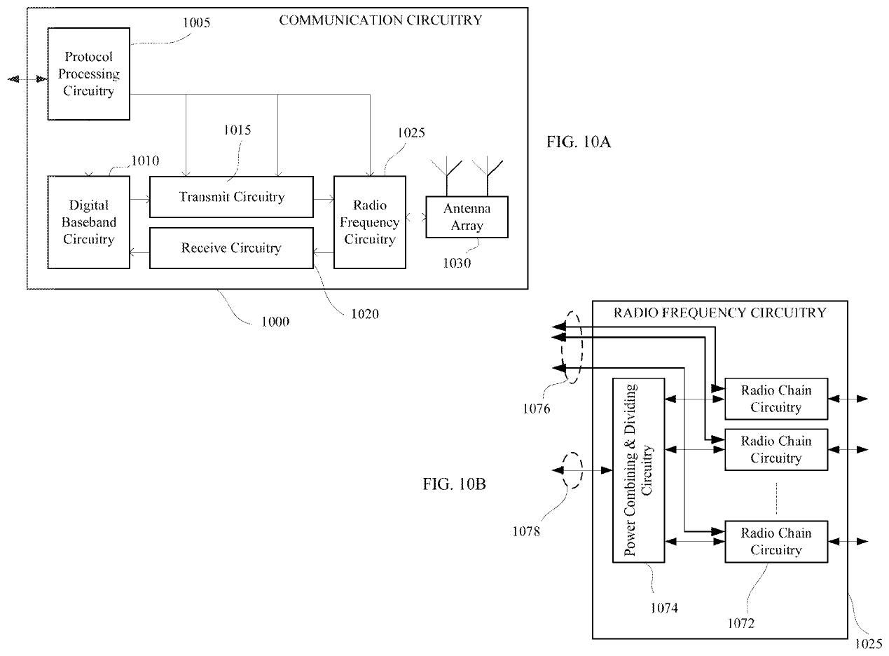

FIG. 10A illustrates an embodiment of communication circuitry 1000 such as the circuitry in the base station 510 and the user equipment 560 shown and discussed in conjunction with FIG. 5 or other FIGs. herein. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 544 and 594 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 544 and 594 illustrated and discussed in conjunction with FIG. 5 or other FIGs. herein. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

FIG. 11 illustrates an example of a storage medium 1100 to store code and data for execution by any one or more of the processors and/or processing circuitry to perform the functionality of the logic circuitry described herein in conjunction with FIGS. 1-10 and 12-15. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 12 illustrates an architecture of a system 1200 of a network in accordance with some embodiments. The system 1200 is shown to include a user equipment (UE) 1510 and a UE 1522 such as the UEs discussed in conjunction with FIGS. 1-11. The UEs 1510 and 1522 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1510 and 1522 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1510 and 1522 may to connect, e.g., communicatively couple, with a radio access network (RAN)-in this embodiment, an Evolved Universal Mobile Telecommunications System (UMTS) Terrestrial Radio Access Network (E-UTRAN) 1210 such as the base stations shown in FIGS. 1-11. The UEs 1510 and 1522 utilize connections 1520 and 1204, respectively, each of which comprises a physical communications interface or layer (discussed in further detail below); in this example, the connections 1520 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1510 and 1522 may further directly exchange communication data via a ProSe interface 1205. The ProSc interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1522 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1520 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro-RAN node 1560, and one or more RAN nodes for providing femto-cells or picocells (e.g., cells having smaller coverage areas, smaller user capacity, or higher bandwidth compared to macro-cells), e.g., low power (LP) RAN node 1572.

Any of the RAN nodes 1560 and 1572 can terminate the air interface protocol and can be the first point of contact for the UEs 1510 and 1522. In some embodiments, any of the RAN nodes 1560 and 1572 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1510 and 1522 can be configured to communicate using Orthogonal Frequency-Division Multiplexing (OFDM) communication signals with each other or with any of the RAN nodes 1560 and 1572 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1560 and 1572 to the UEs 1510 and 1522, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks. The physical downlink shared channel (PDSCH) may carry user data and higher-layer signaling to the UEs 1510 and 1522. The physical downlink control channel (PDCCH) may carry information about the transport format and resource allocations related to the PDSCH channel, among other things. It may also inform the UEs 1510 and 1522 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1560 and 1572 based on channel quality information fed back from any of the UEs 1510 and 1522. The downlink resource assignment information may be sent on the PDCCH used for (e.g., assigned to) each of the UEs 1510 and 1522.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1560 and 1572 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network—in this embodiment, an Evolved Packet Core (EPC) network 1220 via an S1 interface 1570. In this embodiment the S1 interface 1570 is split into two parts: the SI-U interface 1214, which carries traffic data between the RAN nodes 1560 and 1572 and the serving gateway (S-GW) 1222, and the SI-mobility management entity (MME) interface 1215, which is a signaling interface between the RAN nodes 1560 and 1572 and MMEs 1546.

In this embodiment, the EPC network 1220 comprises the MMEs 1546, the S-GW 1222, the Packet Data Network (PDN) Gateway (P-GW) 1223, and a home subscriber server (HSS) 1224. The MMEs 1546 may be similar in function to the control plane of legacy Serving General Packet Radio Service (GPRS) Support Nodes (SGSN). The MMEs 1546 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the S1 interface 1570 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VOIP) sessions, PTT sessions, group communication sessions, social networking services, etc.) for the UEs 1510 and 1522 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs discussed in conjunction with FIGS. 1-12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuitry 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 510 and the user equipment 560 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown and/or discussed in conjunction with FIGS. 1-13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., interfaces 525 and 575 shown in FIG. 5 for communications or network communications or other interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein in conjunction with FIGS. 1-14. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors. Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

### Some Advantage Effects of Embodiments

While not an exhaustive list, several embodiments have one or more potentially advantages effects. The enhancements advantageously to perform positioning frequency hops for positioning measurements wherein all positioning frequency layers are measured or associated with only one per-UE measurement gap or all positioning frequency layers in the same FR are measured or associated with only one per-FR measurement gap in the corresponding FR. For instance, a UE may be configured with one measurement gap for positioning measurements for a per UE measurement gap configuration. Alternatively, the UE may be configured with one measurement gap for FR1 positioning measurements, one measurement gap for FR2 positioning measurements, or one measurement gap for FR1 positioning measurements and one measurement gap for FR2 positioning measurements for a per FR measurement gap configuration The enhancements advantageously maintain an active connection with a base station for data UL and DL. The enhancements advantageously reduce complexity of measurement for RedCap UEs. The enhancements advantageously facilitate measurement of PRS bandwidths that are larger than the bandwidth capabilities of the UE.

### Examples of Further Embodiments

The following examples pertain to further embodiments. Specifics in the examples may be used anywhere in one or more embodiments.

Example 1 is an apparatus of user equipment (UE) for positioning reference signal (PRS) reception with frequency hops, comprising an interface for communications; processing circuitry coupled with a memory and the interface to perform operations to determine, based on a PRS configuration, a frequency range of a PRS, wherein the PRS configuration defines resource blocks of positioning frequency layers of the PRS; determine a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay; perform the number of frequency hops and measurements of the PRS during each of the repetitions of the one measurement gap or the up to two measurement gaps; and cause transmission of at least one positioning measurement report via the interface. In Example 2, the apparatus of Example 1, wherein the processing circuitry comprises a processor and the memory coupled with the processor, the apparatus further comprising radio frequency circuitry coupled with the processing circuitry, and one or more antennas coupled with the radio frequency circuitry. In Example 3, the apparatus of Example 1, wherein each of the frequency layers associated with the number of frequency hops during a repetition of one measurement gap or the up to two measurement gaps is associated with a bandwidth part of the PRS. In Example 4, the apparatus of Example 1, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement. In Example 5, the apparatus of Example 4, wherein the UE is configured with the positioning measurement configuration via a base station by a location management function of a core network and the positioning measurement configuration resides in the memory. In Example 6, the apparatus of Example 4, wherein the at least one measurement delay is defined per measurement type and comprises a maximum of four repetitions of the one measurement gap or the up to two measurement gaps, wherein the processing circuitry causes transmission of each of the at least one positioning measurement report within a corresponding measurement delay per measurement type. In Example 7, the apparatus of any of Examples 1-6, wherein all positioning frequency layers are measured or associated with only one per-UE measurement gap. In Example 8, the apparatus of any of Examples 1-6, wherein all positioning frequency layers in a same FR are measured or associated with only one per-FR measurement gap in a corresponding FR.

Example 9 is a method of user equipment (UE) for positioning reference signal (PRS) reception with frequency hops, comprising determining, based on a PRS configuration, a frequency range of a PRS, wherein the PRS configuration defines resource blocks of positioning frequency layers of the PRS; determining a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay; performing the number of frequency hops and measurements of the PRS during each of the repetitions of the one measurement gap or the up to two measurement gaps; and causing transmission of at least one positioning measurement report via an interface. In Example 10, the method of Example 9, wherein each of the frequency layers associated with the number of frequency hops during a repetition of one measurement gap or the up to two measurement gaps is associated with a bandwidth part of the PRS. In Example 11, the method of Example 9, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement. In Example 12, the method of any of Examples 9-11, wherein all positioning frequency layers are measured or associated with only one per-UE measurement gap. In Example 13, the method of any of Examples 9-11, wherein all positioning frequency layers in a same FR are measured or associated with only one per-FR measurement gap in a corresponding FR.

Example 14 is a machine-readable medium containing instructions, which when executed by a processor of user equipment (UE) for positioning reference signal (PRS) reception with frequency hops, cause the processor to perform operations, the operations to determine, based on a PRS configuration, a frequency range of a PRS, wherein the PRS configuration defines resource blocks of positioning frequency layers of the PRS; determine a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay; perform the number of frequency hops and measurements of the PRS during each of the repetitions of the one measurement gap or the up to two measurement gaps; and cause transmission of at least one positioning measurement report via an interface. In Example 15, the machine-readable medium of Example 14, wherein each of the frequency layers associated with the number of frequency hops during a repetition of one measurement gap or the up to two measurement gaps is associated with a bandwidth part of the PRS. In Example 16, the machine-readable medium of Example 14, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement. In Example 17, the machine-readable medium of Example 16, wherein the UE is configured with the positioning measurement configuration via a base station by a location management function of a core network and the positioning measurement configuration resides in a memory. In Example 18, the machine-readable medium of Example 16, wherein the at least one measurement delay is defined per measurement type and comprises a maximum of four repetitions of the one measurement gap or the up to two measurement gaps, wherein the processor causes transmission of each of the at least one positioning measurement report within a corresponding measurement delay per measurement type. In Example 19, the machine-readable medium of any of Examples 14-18, wherein all positioning frequency layers are measured or associated with only one per-UE measurement gap. In Example 20, the machine-readable medium of any one of Examples 14-18, wherein all positioning frequency layers in a same FR are measured or associated with only one per-FR measurement gap in a corresponding FR.

Example 21 is a method comprising any action described in any one of Examples 1-20.

Example 22 is an apparatus comprising a means for any method in Example 21.

Example 23 is a system comprising a means for any method in Example 21 such as the system described in Example 2 and the system described in Example 15.

Example 24 is a machine-readable medium containing instructions, which when executed by a processor, cause the processor to perform operations, the operations including any method in Example 21.

1-20. (canceled)

21. An apparatus of user equipment (UE) for positioning reference signal (PRS) reception with frequency hops, comprising:
an interface for communications;
processing circuitry coupled with a memory and the interface to perform operations to:
determine, based on a PRS configuration, a frequency range of a PRS, wherein the PRS configuration defines resource blocks of positioning frequency layers of the PRS;
determine a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay;
perform the number of frequency hops and measurements of the PRS during each of the repetitions of the one measurement gap or the up to two measurement gaps; and
cause transmission of at least one positioning measurement report via the interface.

22. The apparatus of claim 21, wherein the processing circuitry comprises a processor and the memory coupled with the processor, the apparatus further comprising radio frequency circuitry coupled with the processing circuitry, and one or more antennas coupled with the radio frequency circuitry.

23. The apparatus of claim 21, wherein each of the frequency layers associated with the number of frequency hops during a repetition of one measurement gap or the up to two measurement gaps is associated with a bandwidth part of the PRS.

24. The apparatus of claim 21, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement.

25. The apparatus of claim 24, wherein the UE is configured with the positioning measurement configuration via a base station by a location management function of a core network and the positioning measurement configuration resides in the memory.

26. The apparatus of claim 24, wherein the at least one measurement delay is defined per measurement type and comprises a maximum of four repetitions of the one measurement gap or the up to two measurement gaps, wherein the processing circuitry causes transmission of each of the at least one positioning measurement report within a corresponding measurement delay per measurement type.

27. The apparatus of claim 21, wherein all positioning frequency layers are measured or associated with only one per-UE measurement gap.

28. The apparatus of claim 21, wherein all positioning frequency layers in a same FR are measured or associated with only one per-FR measurement gap in a corresponding FR.

29. A method of user equipment (UE) for positioning reference signal (PRS) reception with frequency hops, comprising:
determining, based on a PRS configuration, a frequency range of a PRS, wherein the PRS configuration defines resource blocks of positioning frequency layers of the PRS;
determining a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay;
performing the number of frequency hops and measurements of the PRS during each of the repetitions of the one measurement gap or the up to two measurement gaps; and
causing transmission of at least one positioning measurement report via an interface.

30. The method of claim 29, wherein each of the frequency layers associated with the number of frequency hops during a repetition of one measurement gap or the up to two measurement gaps is associated with a bandwidth part of the PRS.

31. The method of claim 29, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement.

32. The method of claim 29, wherein all positioning frequency layers are measured or associated with only one per-UE measurement gap.

33. The method of claim 29, wherein all positioning frequency layers in a same FR are measured or associated with only one per-FR measurement gap in a corresponding FR.

34. A machine-readable medium containing instructions, which when executed by a processor of user equipment (UE) for positioning reference signal (PRS) reception with frequency hops, cause the processor to perform operations, the operations to:
determine, based on a PRS configuration, a frequency range of a PRS, wherein the PRS configuration defines resource blocks of positioning frequency layers of the PRS;
determine a number of frequency hops between positioning frequency layers associated with the frequency range of the PRS during repetitions of one measurement gap based on a per UE measurement gap configuration or up to two measurement gaps based on a per frequency range (FR) measurement gap configuration, to perform measurements of the PRS within at least one measurement delay;
perform the number of frequency hops and measurements of the PRS during each of the repetitions of the one measurement gap or the up to two measurement gaps; and
cause transmission of at least one positioning measurement report via an interface.

35. The machine-readable medium of claim 34, wherein each of the frequency layers associated with the number of frequency hops during a repetition of one measurement gap or the up to two measurement gaps is associated with a bandwidth part of the PRS.

36. The machine-readable medium of claim 34, wherein timing between the number of frequency hops is based on an accuracy for positioning measurements defined per measurement type in a positioning measurement configuration, wherein the measurement types comprise a reference signal time difference (RSTD) measurement, a positioning reference signal-reference signal received power (PRS-RSRP) measurement, a UE Rx-TX time difference measurement, and a positioning reference signal-received signal received path power (PRS-RSRPP) measurement.

37. The machine-readable medium of claim 36, wherein the UE is configured with the positioning measurement configuration via a base station by a location management function of a core network and the positioning measurement configuration resides in a memory.

38. The machine-readable medium of claim 36, wherein the at least one measurement delay is defined per measurement type and comprises a maximum of four repetitions of the one measurement gap or the up to two measurement gaps, wherein the processor causes transmission of each of the at least one positioning measurement report within a corresponding measurement delay per measurement type.

39. The machine-readable medium claim 34, wherein all positioning frequency layers are measured or associated with only one per-UE measurement gap.

40. The machine-readable medium claim 34, wherein all positioning frequency layers in a same FR are measured or associated with only one per-FR measurement gap in a corresponding FR.
